(19) United States
(12) Patent Application Publication
(10) Pub. No.: US 2007/0013847 A1
(43) Pub. Date: Jan. 18, 2007

(54) LIQUID CRYSTAL DISPLAY AND PANEL THEREFOR

(75) Inventors: Myeong-Ha KYE, Seoul (KR); Nak-Cho CHOI, Seoul (KR); Chang-Hun LEE, Yongin-si (KR); Sung-Hwan HONG, Suwon-si (KR); Il-Kook HUH, Yongin-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 11/424,114

(22) Filed: Jun. 14, 2006

(30) Foreign Application Priority Data
Jul. 13, 2005 (KR) 10-2005-0063400

(51) Int. Cl. G02F 1/1337

(52) U.S. Cl. 349/129

(57) ABSTRACT

A thin film panel that includes a first substrate, a first slope member formed on the first substrate, a first alignment layer formed on the first substrate and the first slope member, a second substrate opposing the first substrate, and a second alignment layer formed on the second substrate. A rubbing direction of the first alignment layer is perpendicular to a rubbing direction of the second alignment layer.

### CROSS REFERENCE TO RELATED APPLICATION

This application claims priority from Korean Patent Application Number 10-2005-0063400, filed on Jul. 13, 2005, and all the benefits accruing therefrom under 35 U.S.C. § 119, the contents of which are incorporated by reference herein in its entirety.

### BACKGROUND OF THE INVENTION

1. Field of the Invention

The present invention relates to a liquid crystal display and a panel for the liquid crystal display.

2. Discussion of the Background

Liquid crystal displays (LCD) are one of the most widely used flat panel displays. Generally, an LCD includes two panels provided with field-generating electrodes, such as pixel electrodes and a common electrode, and a liquid crystal (LC) layer interposed therebetween. The LCD displays images by applying voltages to the field-generating electrodes to generate an electric field in the LC layer, thereby determining orientations of LC molecules in the LC layer and adjusting polarization of incident light.

Twisted nematic (TN) mode LCDs are popular LCDs. The TN mode LCD has LC molecules that, in the absence of an applied electric field, are aligned such that the long axes of the LC molecules are parallel to the panels and they are sequentially twisted from the upper panel to the lower panel by a 90° angle, and are vertically aligned during application of an electric field.

However, the TN mode LCD typically has a narrow viewing angle. Accordingly, a multi-domain LCD may be fabricated to provide a wider viewing angle. In the multi-domain LCD, the long axes of the LC molecules of a unit pixel or in a pixel are aligned in several directions, thereby dividing the pixel into multiple domains.

In this TN mode LCD, the multi-domain structure may be achieved by rubbing the LC alignment layer in several directions, or by changing the many electric fields applied to the LC molecules.

However, when rubbing the alignment layer in different directions, because the alignment layer is typically rubbed in different directions in each domain, the manufacturing process is complicated and expensive.

### SUMMARY OF INVENTION

The present invention provides a panel and a liquid crystal display including the panel in which multi-domains in the TN mode LCD may be easily formed.

Additional features of the invention will be set forth in the description which follows, and in part will be apparent from the description, or may be learned by practice of the invention.

The present invention discloses a liquid crystal display panel that includes a substrate, a slope member arranged on the substrate, and an alignment layer arranged on the substrate and the slope member. The alignment layer includes grooves, and substantially all of the grooves are substantially arranged in the same direction.

The present invention also discloses a liquid crystal display including a first substrate, a first slope member arranged on the first substrate, a first alignment layer arranged on the first substrate and the first slope member, a second substrate opposing the first substrate, and a second alignment layer arranged on the second substrate. The first alignment layer and the second alignment layer include grooves, all grooves of the first alignment layer are substantially arranged in a first direction, all grooves of the second alignment layer are substantially arranged in a second direction, and the first direction and the second direction are substantially perpendicular to each other.

The present invention also discloses a liquid crystal display including a first substrate, a slope member arranged on the first substrate, a first alignment layer arranged on the first substrate and the slope member, a second substrate opposing the first substrate, a second alignment layer arranged on the second substrate, and a liquid crystal layer arranged between the first and second substrates. The liquid crystal layer includes liquid crystal molecules, and liquid crystal molecules in a region where the slope member is arranged are raised in the opposite direction of liquid crystal molecules in a region without a slope member.

The present invention also discloses a liquid crystal display including a first substrate, a first slope member arranged on the first substrate, a first alignment layer arranged on the first substrate and the first slope member, a second substrate opposing the first substrate, a second slope member arranged on the second substrate, a second alignment layer arranged on the second substrate and the second slope member, and a liquid crystal layer arranged between the first and second substrates and having liquid crystal molecules and positive dielectric anisotropy. Liquid crystal molecules in a region where the first slope member is arranged are raised in the opposite direction of liquid crystal molecules in a region without a first slope member, and the first slope member and the second slope member comprise an organic material.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a layout view of an LCD according to an exemplary embodiment of the present invention.

FIG. 2 and FIG. 3 are sectional views taken along lines II-II and III-III, respectively, of FIG. 1.

FIG. 4 is a sectional view showing a structure of a slope member of an LCD according to an exemplary embodiment of the present invention.

FIG. 5 is a sectional view showing the pre-tilt angle of the liquid crystal molecules by the slope member in the LCD according to an exemplary embodiment of the present invention.

FIG. 6A is a layout view showing four pixels in the LCD shown in FIG. 1 according to an exemplary embodiment of the present invention.

FIG. 6B is a sectional view of the LCD shown in FIG. 5 taken along line VIB-VIB of FIG. 6A.

FIG. 6C is a view showing the pre-tilt directions of the liquid crystal molecules in the four pixels of FIG. 6A according to an exemplary embodiment of the present invention.

FIG. 7 is a layout view of an LCD according to another exemplary embodiment of the present invention.

FIG. 8 and FIG. 9 are sectional views of an LCD taken along lines VIII-VIII and IX-IX, respectively, of FIG. 7.

### DETAILED DESCRIPTION OF THE ILLUSTRATED EMBODIMENTS

The present invention will be described more fully hereinafter with reference to the accompanying drawings, in which exemplary embodiments of the invention are shown. The present invention may, however, be embodied in many different forms and should not be construed as limited to the embodiments set forth herein.

In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present. In contrast, when an element is referred to as being “directly on” another element, there are no intervening elements present.

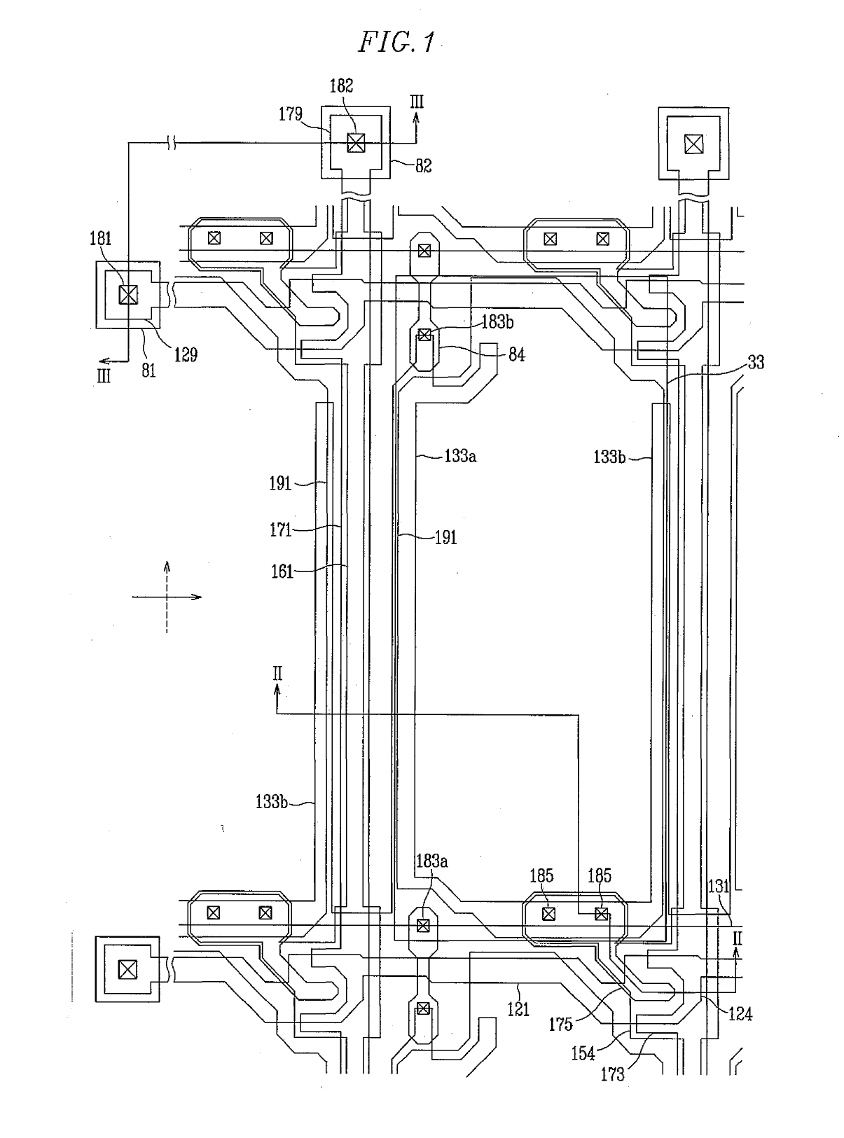

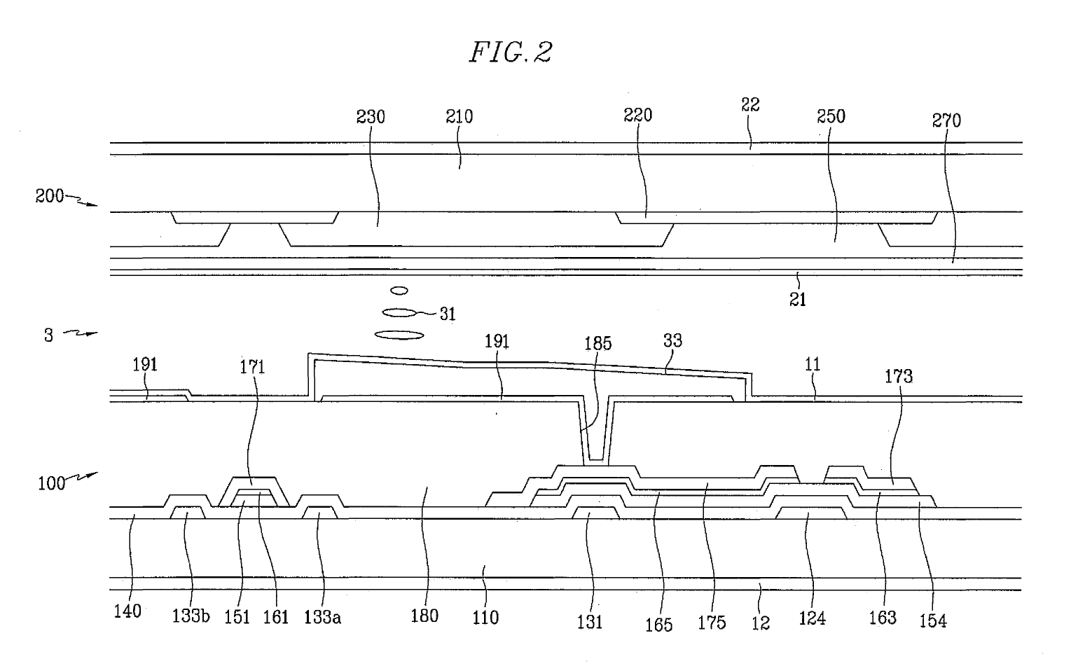

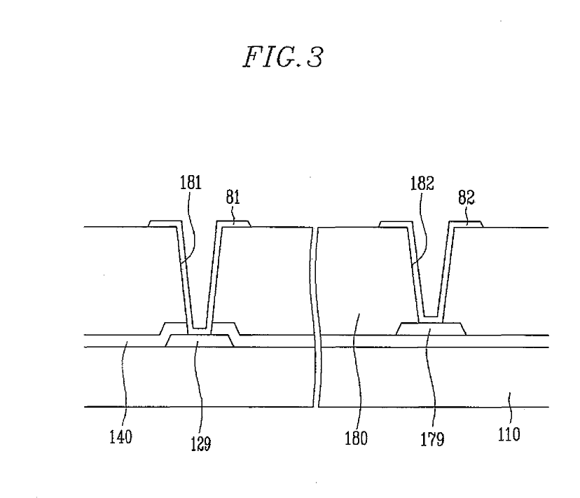

A panel for a liquid crystal display (LCD) and an LCD including the panel according to an exemplary embodiment of the present invention will be described below with reference to FIG. 1, FIG. 2, and FIG. 3.

FIG. 1 is a layout view of an LCD according to an exemplary embodiment of the present invention, and FIG. 2 and FIG. 3 are sectional views taken along lines II-II and III-III, respectively, of FIG. 1.

An LCD according to an exemplary embodiment of the present invention may include a thin film transistor (TFT) array panel 100, a common electrode panel 200 opposing the TFT array panel 100, and a liquid crystal (LC) layer 3 having LC molecules arranged between the panels 100 and 200.

First, a TFT array panel 100 according to an exemplary embodiment of the present invention will be described below with reference to FIG. 1 and FIG. 2.

A plurality of gate lines 121 and a plurality of storage electrode lines 131 are formed on a substrate 110, which may be an insulating substrate made of a material such as transparent glass or plastic.

The gate lines 121 transmit gate signals and extend substantially in a transverse direction. Each gate line 121 includes a plurality of gate electrodes 124, which project downward, and an end portion 129, which has a large area for coupling with another layer or an external driving circuit. A gate driving circuit (not shown) to generate gate signals may be mounted on a flexible printed circuit (FPC) film (not shown), which may be attached to the substrate 110, directly mounted on the substrate 110, or integrated with the substrate 110. The gate lines 121 may extend to be connected with a driving circuit that may be integrated with the substrate 110.

The storage electrode lines 131 are supplied with a predetermined voltage, and each storage electrode line 131 includes a stem, which extends substantially parallel to the gate lines 121, and a plurality of pairs of storage electrodes 133a and 133b, which branch off from the stem. Each storage electrode line 131 is disposed between two adjacent gate lines 121, and the stem is arranged close to one of the two adjacent gate lines 121, as FIG. 1 shows. Each storage electrode 133a and 133b has a fixed end portion connected to the stem and a free end portion disposed opposite thereto. The fixed end portion of the storage electrode 133a has a large area, and its free end portion is bifurcated into a linear branch and a curved branch. However, the storage electrode lines 131 may have various shapes and arrangements.

The gate lines 121 and the storage electrode lines 131 may be made of Al, an Al alloy, Ag, an Ag alloy, Cu, a Cu alloy, Mo, a Mo alloy, Cr, Ta, or Ti. They may have a multi-layered structure including two conductive films (not shown) having different physical characteristics. In this case, one of the two films may be made of a low resistivity metal, such as Al, an Al alloy, Ag, an Ag alloy, Cu, and a Cu alloy, to reduce signal delay or voltage drop. The other film may be made of a material such as Mo, an Mo alloy, Cr, Ta, and Ti, which have good physical, chemical, and electrical contact characteristics with other materials such as indium tin oxide (ITO) or indium zinc oxide (IZO). Examples of the multi-layered structure include a lower Cr film and an upper Al alloy film and a lower Al film and an upper Mo film. However, the gate line 121 and the storage electrode line 131 may be made of various metals or conductors.

The lateral sides of the gate lines 121 and the storage electrode lines 131 may be inclined relative to a surface of the substrate 110 at an angle that ranges from about 30 to 80 degrees.

A gate insulating layer 140, which may be made of silicon nitride (SiNx) or silicon oxide (SiOx), is formed on the gate lines 121 and the storage electrode lines 131.

A plurality of semiconductor stripes 151, which may be made of hydrogenated amorphous silicon (“a-Si”) or polycrystalline silicon (polysilicon), are formed on the gate insulating layer 140. The semiconductor stripes 151 extend substantially in the longitudinal direction, and they widen near the gate lines 121 and the storage electrode lines 131 to cover large areas of the gate lines 121 and the storage electrode lines 131. Each semiconductor stripe 151 includes a plurality of projections 154 that branch out toward the gate electrodes 124.

A plurality of ohmic contact stripes and islands 161 and 165 are formed on the semiconductor stripes 151. The ohmic contact stripes and islands 161 and 165 may be made of n+ hydrogenated a-Si heavily doped with an N-type impurity such as phosphorous, or they may be made of silicide. Each ohmic contact stripe 161 includes a plurality of projections 163, and the projections 163 and the ohmic contact islands 165 are arranged in pairs on the projections 154 of the semiconductor stripes 151.

The lateral sides of the semiconductor stripes 151 and the ohmic contacts 161 and 165 are inclined relative to the surface of the substrate 110 at an angle in a range of about 30 to 80 degrees.

A plurality of data lines 171 and a plurality of drain electrodes 175 are formed on the ohmic contacts 161 and 165, respectively, and the gate insulating layer 140.

The data lines 171 transmit data signals and extend substantially in the longitudinal direction to cross the gate lines 121. Each data line 171 also crosses the storage electrode lines 131 and runs between adjacent pairs of storage electrodes 133a and 133b. Each data line 171 includes a plurality of source electrodes 173, which project toward the gate electrodes 124 and are curved like a crescent, and an end portion 179 that has a large area for coupling with another layer or an external driving circuit. A data driving circuit (not shown) to generate data signals may be mounted on an FPC film (not shown), which may be attached to the substrate 110, directly mounted on the substrate 110, or integrated with the substrate 110. The data lines 171 may extend to be connected with a driving circuit that may be integrated with the substrate 110.

The drain electrodes 175 are separated from the data lines 171 and disposed opposing the source electrodes 173 with respect to the gate electrodes 124. Each drain electrode 175 includes a wide end portion and a narrow end portion. The wide end portion overlaps a storage electrode line 131, and the narrow end portion is partly enclosed by the crescent-shaped source electrode 173.

A gate electrode 124, a source electrode 173, a drain electrode 175, and a projection 154 of a semiconductor stripe 151 form a TFT having a channel formed in a portion of the projection 154 disposed between the source electrode 173 and the drain electrode 175.

The data lines 171 and the drain electrodes 175 may be made of a refractory metal such as Cr, Mo, Ti, Ta or alloys thereof. They may have a multi-layered structure including a low-resistivity film (not shown) and a good-contact film (not shown). Examples of the multi-layered structure include a lower Mo film, an intermediate Al film, and an upper Mo film, as well as the above-described combinations of a lower Cr film and an upper Al—Nd alloy film and a lower Al film and an upper Mo film. However, the data lines 171 and the drain electrodes 175 may be made of various metals or conductors.

The data lines 171 and the drain electrodes 175 may have inclined edge profiles, and the inclination angles may range from about 30 to 80 degrees.

The ohmic contacts 161, which include the projections 163, and 165 are interposed between the underlying semiconductor stripes 151 and the overlying conductors 171 and 175 to reduce the contact resistance therebetween. Although the semiconductor stripes 151 are narrower than the data lines 171 at most places, the semiconductor stripes 151 widen near the gate lines 121 and the storage electrode lines 131, as described above, to smooth the profile of the surface, thereby preventing disconnection of the data lines 171. The semiconductor stripes 151 have a similar planar shape as the data lines 171 and the drain electrodes 175, as well as the ohmic contacts 161 and 165. However, the semiconductor stripes 151 include some exposed portions, which are not covered with the data lines 171 and the drain electrodes 175, such as the portions of the projections 154 located between the source electrodes 173 and the drain electrodes 175.

A passivation layer 180 is formed on the data lines 171, the drain electrodes 175, and the exposed portions of the semiconductor stripes 151. The passivation layer 180 may be made of an inorganic or organic insulator, and it may have a flat, top surface. Examples of the inorganic insulator material include silicon nitride and silicon oxide. The organic insulator may have photosensitivity and a dielectric constant of less than about 4.0. The passivation layer 180 may include a lower film of an inorganic insulator and an upper film of an organic insulator to utilize the insulating characteristics of the organic insulator while preventing the organic insulator from damaging the exposed portions of the semiconductor stripes 151.

The passivation layer 180 has a plurality of contact holes 182 and 185 that expose the data line end portions 179 and the drain electrodes 175, respectively. The passivation layer 180 and the gate insulating layer 140 have a plurality of contact holes 181 that expose the gate line end portions 129, a plurality of contact holes 183a that expose portions of the storage electrode lines 131 near the fixed end portions of the storage electrodes 133a, and a plurality of contact holes 183b that expose the linear branches of the free end portions of the storage electrodes 133a.

A plurality of pixel electrodes 191, a plurality of overpasses 84, and a plurality of contact assistants 81 and 82 are formed on the passivation layer 180. They may be made of a transparent conductor such as ITO or IZO, or a reflective conductor such as Ag, Al, Cr, or alloys thereof.

The pixel electrodes 191 are coupled with the drain electrodes 175 through the contact holes 185 to receive data voltages from the drain electrodes 175. The pixel electrodes 191 that are supplied with a data voltage generate an electric field in cooperation with a common electrode 270 of the opposing common electrode panel 200, which is supplied with a common voltage, thereby determining the orientations of LC molecules 31 of a LC layer 3 disposed between the TFT array and common electrode panels 100 and 200. A pixel electrode 191 and the common electrode 270 form a capacitor referred to as a “liquid crystal capacitor,” which stores applied voltages after the TFT turns off.

A pixel electrode 191 overlaps a storage electrode line 131 including storage electrodes 133a and 133b. The pixel electrode 191, a drain electrode 175 coupled thereto, and the storage electrode line 131 form an additional capacitor referred to as a “storage capacitor,” which enhances the liquid crystal capacitor's voltage storing capacity.

The overpasses 84 cross over the gate lines 121 and are coupled with the exposed portions of the storage electrode lines 131 and the exposed linear branches of the free end portions of the storage electrodes 133a through the contact holes 183a and 183b, respectively, which are disposed on opposite sides of the gate lines 121. The storage electrode lines 131 including the storage electrodes 133a and 133b along with the overpasses 84 can be used to compensate for defects in the gate lines 121, the data lines 171, or the TFTs.

The contact assistants 81 and 82 are coupled with the end portions 129 of the gate lines 121 and the end portions 179 of the data lines 171 through the contact holes 181 and 182, respectively. The contact assistants 81 and 82 protect the end portions 129 and 179 and enhance the adhesion between the end portions 129 and 179 and external devices.

A plurality of slope members 33 are formed on the passivation layer 180 and the pixel electrodes 191. The slope members 33 may be disposed in all or selected pixel regions.

The slope members 33 have a surface that declines in the direction of the arrow with the solid line in FIG. 1. The slope members 33 may be formed of a transparent organic material.

An alignment layer 11 is formed on the passivation layer 180 and the slope members 33. The alignment layer 11 is rubbed in the direction of the arrow with the solid line in FIG. 1, which is the same direction as the declination of the slope members 33.

A description of the common electrode panel 200 follows with reference to FIG. 2.

A light blocking member 220, which is typically called a black matrix, is formed on a substrate 210 to prevent light leakage. The substrate 210 may be an insulating substrate made of a transparent material such as glass. The light blocking member 220 may include a plurality of openings (not shown) that face the pixel electrodes 191, and it may have substantially the same planar shape as the pixel electrodes 191. Alternatively, the light blocking member 220 may include linear portions that correspond to the data lines 171 and the gate lines 121, and other portions that correspond to the TFTs.

A plurality of color filters 230 are formed on the substrate 210, and they are disposed substantially in the areas enclosed by the light blocking member 220. The color filters 230 may extend substantially in the longitudinal direction along the pixel electrodes 191. The color filters 230 may represent one of the primary colors such as red, green, and blue.

An overcoat 250 is formed on the color filters 230 and the light blocking member 220. The overcoat 250 may be made of an (organic) insulator, and it prevents the color filters 230 from being exposed and provides a flat surface. The overcoat 250 may be omitted.

A common electrode 270 is formed on the overcoat 250. The common electrode 270 may be made of a transparent conductive material such as ITO and IZO.

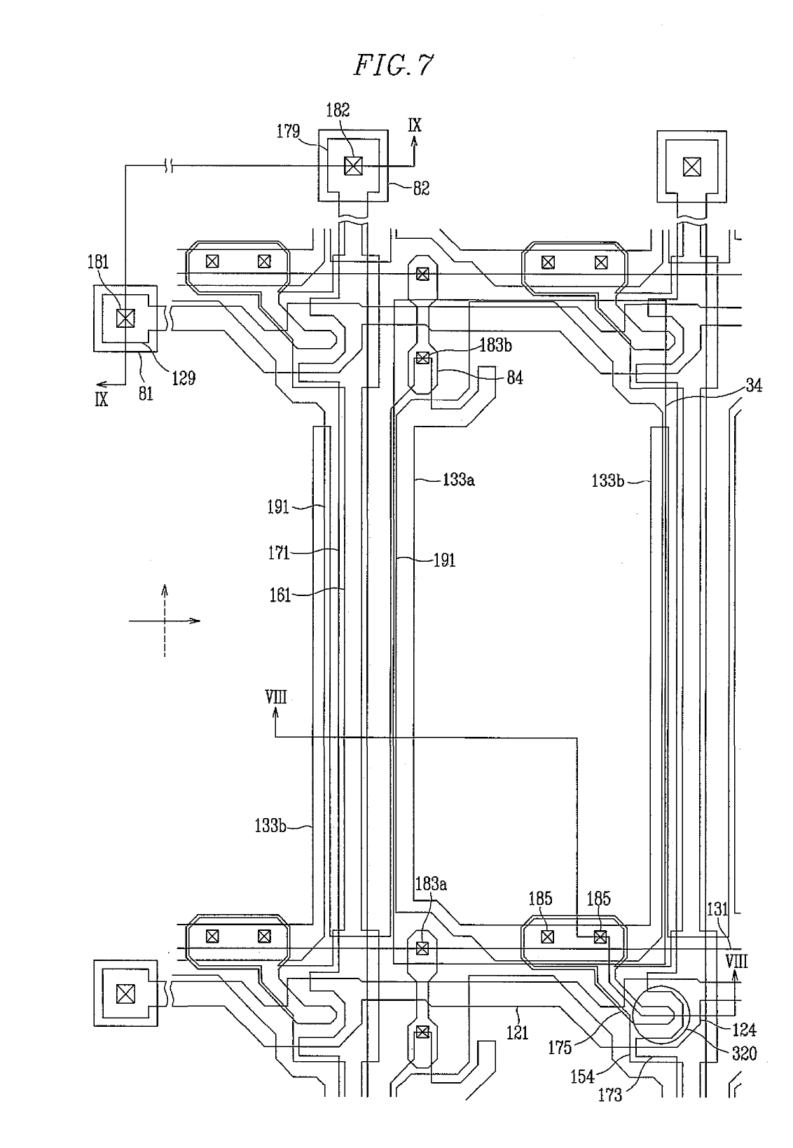

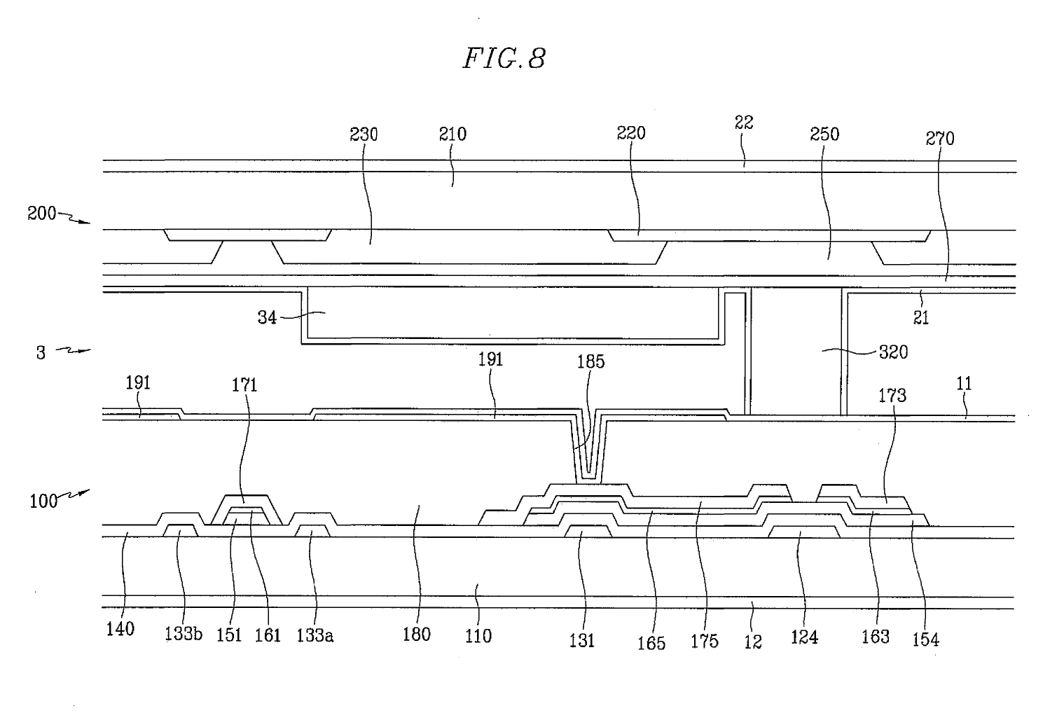

A plurality of slope members (e.g., see reference character 34 in FIG. 7 and FIG. 8) may also be formed on the common electrode 270, and a surface of the slope members may decline in the direction of the arrow with the dotted line in FIG. 1.

An alignment layer 21 is formed on the common electrode 270, and the alignment layer 21 is rubbed in the direction of the arrow with the dotted line in FIG. 1.

The LC layer 3 is arranged between the panels 100 and 200, and it includes a nematic LC material having positive dielectric anisotropy. The LC molecules 31 in the LC layer 3 are subjected to a horizontal alignment in which they are aligned such that their long axes are substantially horizontal to the surfaces of the panels 100 and 200 in the absence of an electric field, and are sequentially twisted from panel 100 to panel 200 in the range of a 90° angle. The LC molecules 31 have the twisted structure with the spiral shape.

Polarizers 12 and 22 are provided on outer surfaces of the panels 100 and 200, respectively, such that their polarization axes may cross and one of the transmissive axes may be parallel to the gate lines 121. One of the polarizers may be omitted when the LCD is a reflective LCD.

The LCD may further include at least one retardation film (not shown) for compensating the retardation of the LC layer 3. The retardation film has birefringence and retards in a direction opposite to that of the LC layer 3. The retardation film may include a uniaxial or biaxial optical compensation film, and in particular, a negative uniaxial compensation film.

The LCD may further include a backlight unit (not shown) for supplying light to the LC layer 3, the polarizers 12 and 22, the retardation film, and the panels 100 and 200.

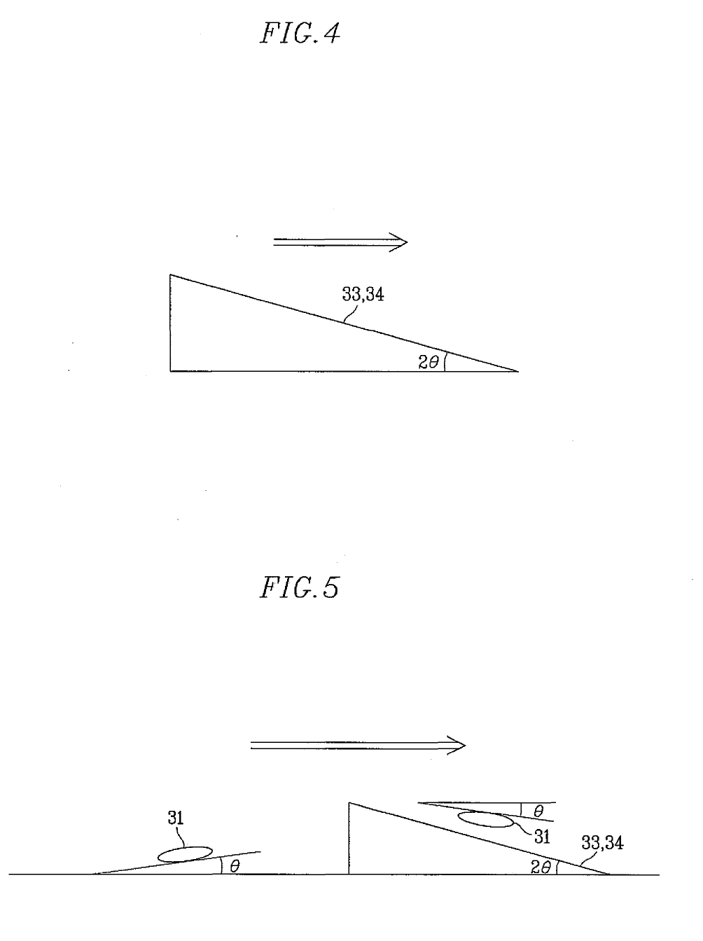

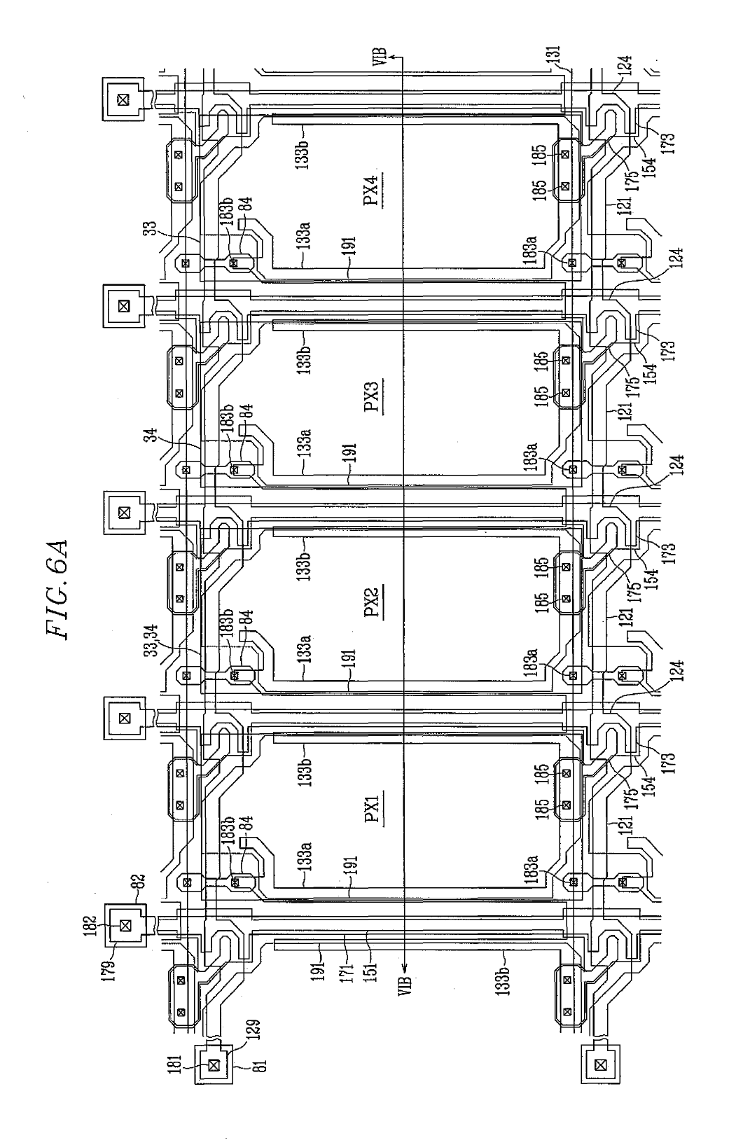

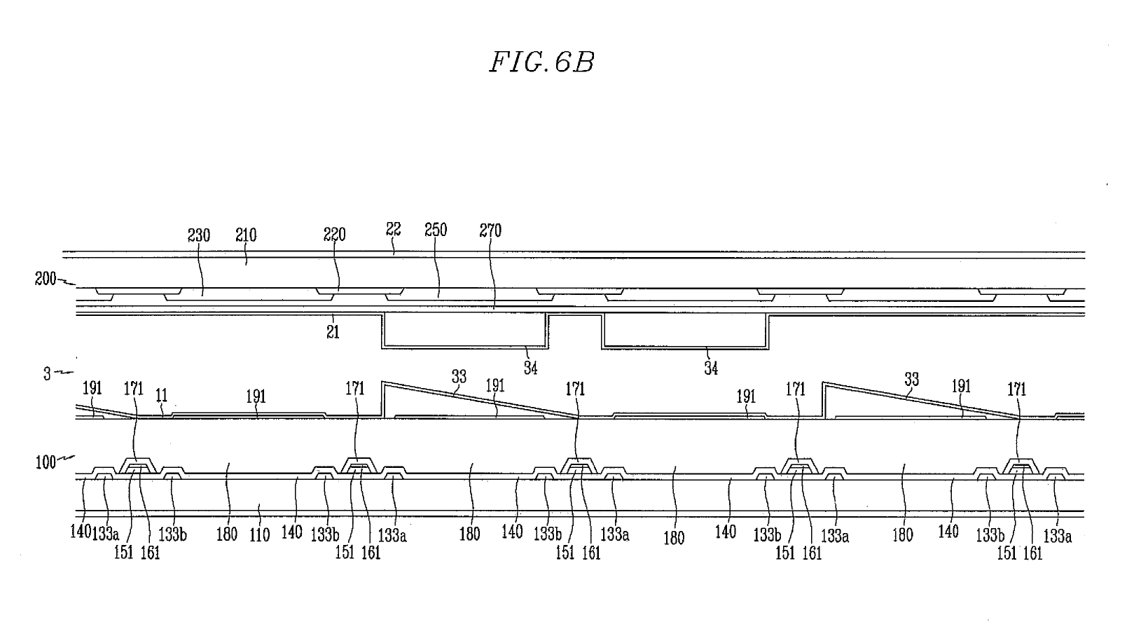

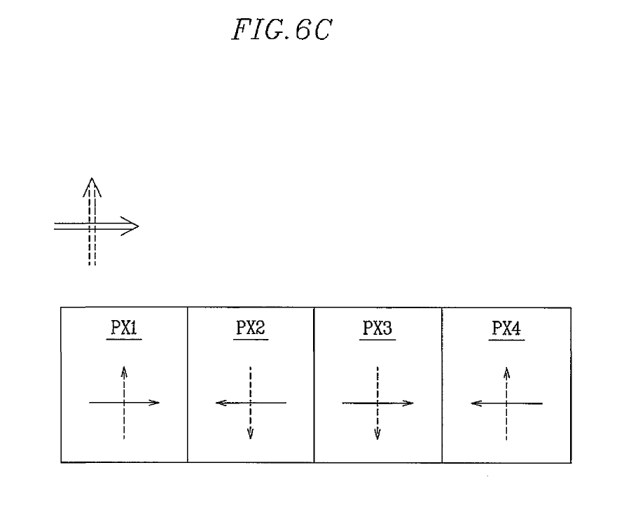

The slope members of the LCD shown in FIG. 1, FIG. 2, and FIG. 3 according to an exemplary embodiment of the present invention will be described below with reference to FIG. 4, FIG. 5, FIG. 6A, FIG. 6B, and FIG. 6C.

FIG. 4 is a sectional view showing a structure of slope members 33 and 34 according to an exemplary embodiment of the present invention, and the large arrow in FIG. 4 shows the rubbing direction.

Rubbing involves scraping the alignment layer in a predetermined direction by using a roller on which a cloth is attached. The cloth includes fibers made of cotton and nylon. Rubbing the alignment layers 11 and 21 forms a plurality of declined grooves on the surface of the alignment layers 11 and 21, and the LC molecules 31 are aligned according to the declination of these grooves. In this case, the LC molecules 31 are declined, the declination angle of the LC molecules 31 is called a ‘pre-tilt angle’, and the pre-tilt angle θ of the LC molecules 31 may be regulated by the number of rotations of the roller, the rotation velocity, the number of rubs, the length of the cloth's fibers, or the thickness of the cloth's fibers.

As described above, the slope members 33 and 34 decline in the rubbing direction, and the slope angle of the oblique side A of the slope members 33 and 34 is twice the pre-tilt angle θ of the LC molecules 31 caused by the rubbing. It is preferable that the slope angle of the oblique side A is in the range of 5 to 10 degrees.

FIG. 5 is a sectional view showing the pre-tilt angle of the LC molecules 31 caused by the slope member 33, 34 in the LCD according to an exemplary embodiment of the present invention.

As shown in FIG. 5, the LC molecules 31 disposed in areas without the slope members 33 and 34 are raised with the pre-tilt angle θ because of the rubbing, and the LC molecules 31 disposed in areas with the slope members 33 and 34 are declined by the rubbing and the oblique side A such that the LC molecules 31 are raised with the pre-tilt angle of −θ.

Accordingly, although the one rubbing process is executed, the LC molecules 31 may be raised in opposite directions in regions with and without the slope members 33 and 34, thereby achieving the same effect of rubbing multi-domains in different directions. Consequently, even though all grooves of the alignment layer are substantially arranged in the same direction, multi-domains having different pre-tilt angles may achieved.

For the plurality of pixels in the LCD according to the present invention, the variations of the pre-tilt angle of the LC molecules 31 according to the slope members 33 and 34 will be described below with reference to FIG. 6A, FIG. 6B, and FIG. 6C.

FIG. 6A is a layout view showing four pixels in the LCD shown in FIG. 1 according to an exemplary embodiment of the present invention, FIG. 6B is a sectional view taken along line VIB-VIB of FIG. 6A, and FIG. 6C is a view showing the pre-tilt directions of the LC molecules 31 in the four pixels of FIG. 6A.

Referring to FIG. 6C, the thick arrow with the solid lines indicates the rubbing direction of the alignment layer 11 of the TFT array panel 100, and the thick arrow with the dotted lines indicates the rubbing direction of the alignment layer 21 of the common electrode panel 200.

As shown in FIG. 6A and FIG. 6B, a slope member is not formed in a pixel PX1 among four pixels PX1, PX2, PX3, and PX4, which are sequentially arranged. A slope member 33 and a slope member 34 are formed on the TFT array panel 100 and the common electrode panel 200, respectively, in the pixel PX2, a slope member 34 is formed only on the common electrode panel 200 in the pixel PX3, and a slope member 33 is formed only on the TFT array panel 100 in the pixel PX4.

As described above, the slope members 33 and 34 are declined in the rubbing direction of the alignment layers 11 and 21, respectively, and the declination of the slope member 33 is substantially perpendicular to the declination of the slope member 34.

As described above with reference to FIG. 4 and FIG. 5, the LC molecules 31 are raised in opposite directions in regions with and without the slope members 33 and 34, such that the pixels with and without the slope members 33 and 34 have the effect that the LC molecules 31 are rubbed in opposite directions. Accordingly, the LC molecules 31 of the pixels of FIG. 6A and FIG. 6B are raised in different directions, as shown in FIG. 6C.

In FIG. 6C, as noted above, the thick arrow with the solid lines indicates the rubbing direction of the alignment layer 11, and the thick arrow with the dotted lines indicates the rubbing direction of the alignment layer 21. Furthermore, the thin arrow with the solid line indicates the raising direction of the LC molecules 31 on the surface of the alignment layer 11, and the thin arrow with the dotted line indicates the raising direction of the LC molecules 31 on the surface of the alignment layer 21. Accordingly, the LC molecules in the pixels of the LCD according to an exemplary embodiment of the present invention may be raised and declined in four directions.

Because an LCD according to an exemplary embodiment of the present invention may include a plurality of pixels such as the pixels PX1, PX2, PX3 and PX4 of FIG. 6A, FIG. 6B, and FIG. 6C, even though only one rubbing process is executed, the LC molecules may be raised in four directions in the pixels, thereby providing for multi-domains having different pre-tilt angles.

Furthermore, the slope members 33 and 34 may be formed in a portion of one pixel, and therefore multi-domains having different pre-tilt angles may be arranged in one pixel.

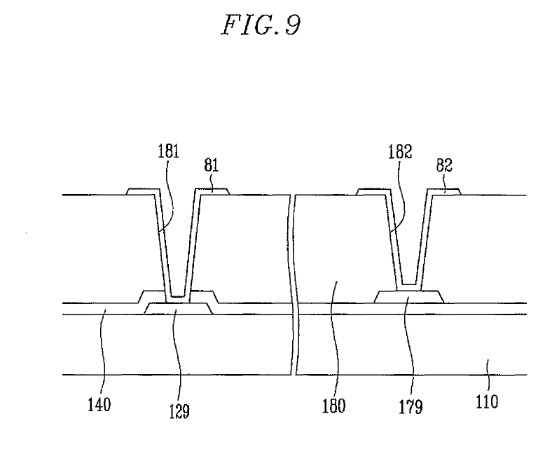

An LCD according to another exemplary embodiment of the present invention will be described below with reference to FIG. 7, FIG. 8, and FIG. 9.

FIG. 7 is an exemplary layout view of an LCD according to another exemplary embodiment of the present invention, and FIG. 8 and FIG. 9 are sectional views taken along lines VIII-VIII and IX-IX, respectively, of FIG. 7.

Referring to FIG. 7, FIG. 8, and FIG. 9, an LCD according to this embodiment also includes a TFT array panel 100, a common electrode panel 200, an LC layer 3 interposed between the panels 100 and 200, and a pair of polarizers 12 and 22 attached on outer surfaces of the panels 100 and 200.

Layered structures of the panels 100 and 200 according to this embodiment are similar to those shown in FIG. 1, FIG. 2, and FIG. 3.

Regarding the TFT array panel 100, a plurality of gate lines 121, which include gate electrodes 124 and end portions 129, and a plurality of storage electrode lines 131 are formed on a substrate 110, and a gate insulating layer 140, a plurality of semiconductor stripes 151, which include projections 154, and a plurality of ohmic contact stripes 161, which include projections 163, and a plurality of ohmic contact islands 165 are sequentially formed thereon. A plurality of data lines 171, which include source electrodes 173 and end portions 179, and a plurality of drain electrodes 175 are formed on the ohmic contacts 161 and 165, respectively, and a passivation layer 180 is formed thereon. A plurality of contact holes 181, 182, 183a, 183b, and 185 are provided in the passivation layer 180 and the gate insulating layer 140. A plurality of pixel electrodes 191, a plurality of contact assistants 81 and 82, and a plurality of overpasses 84 are formed on the passivation layer 180, and an alignment layer 11 is coated thereon. The alignment layer 11 is rubbed in the direction of arrow with the solid line in FIG. 7. A slope member (not shown) may be formed on the pixel electrode 191 and the passivation layer 180, and it may have a surface having a declination slope in the same direction as the rubbing direction.

Regarding the common electrode panel 200, a light blocking member 220, a plurality of color filters 230, a common electrode 270, a slope member 34, and an alignment layer 21 are formed on a substrate 210, which may be an insulating substrate. The slope member 34 is declined in the direction of the arrow with the dotted line, and the alignment layer 21 is rubbed in the direction of the declination slope of the slope member 34.

Unlike the LCD shown in FIG. 1, FIG. 2, and FIG. 3, a plurality of column spacers 320 are formed on the common electrode 270. The column spacers 320 are disposed at positions corresponding to the TFTs, and they maintain a substantially uniform cell gap between the TFT array panel 100 and the common electrode panel 200.

The column spacers 320 may be formed by a photolithography process and be patterned by a photolithography process for the slope members 34.

Many of the above-described features of the LCD shown in FIGS. 1 to 6C may be appropriate for the LCD shown in FIGS. 7 to 9.

As described above, an alignment layer is formed on the slope member having a sloped surface and only one rubbing process need be executed, such that LC molecules are raised in various directions and multi-domains having different pre-tilt angles may be achieved.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A panel for a liquid crystal display, comprising:
a substrate;
a plurality of slope members arranged on the substrate; and
an alignment layer arranged on the substrate and the slope members,
wherein the alignment layer comprises grooves, and substantially all grooves of the alignment layer are substantially arranged in a first direction.

2. The panel of claim 1, wherein a slope member comprises an oblique surface and a side surface connected to the oblique surface, and a declination slope direction of the slope member is the first direction.

3. The panel of claim 2, wherein an inclination angle of the oblique surface of the slope member is twice a pre-tilt angle generated by the grooves.

4. The panel of claim 3, wherein the inclination angle of the oblique surface is in the range of about 5 to 10 degrees.

5. The panel of claim 1, further comprising:
a plurality of gate lines and a plurality of data lines arranged on the substrate;
a plurality of thin film transistors coupled with the gate lines and the data lines; and
a plurality of pixel electrodes coupled with the thin film transistors.

6. The panel of claim 5, wherein each slope member is respectively arranged on one pixel electrode.

7. The panel of claim 5, wherein a plurality of slope members are arranged on one pixel electrode.

8. The panel of claim 1, further comprising a common electrode arranged on the substrate,
wherein the slope members are arranged on the common electrode.

9. A liquid crystal display, comprising:
a first substrate;
a first slope member arranged on the first substrate;
a first alignment layer arranged on the first substrate and the first slope member;
a second substrate opposing the first substrate; and
a second alignment layer arranged on the second substrate,
wherein the first alignment layer and the second alignment layer comprise grooves, substantially all grooves of the first alignment layer are substantially arranged in a first direction, substantially all grooves of the second alignment layer are substantially arranged in a second direction, and the first direction and the second direction are substantially perpendicular to each other.

10. The liquid crystal display of claim 9, wherein a declination slope direction of the first slope member is the first direction.

11. The liquid crystal display of claim 9, further comprising a second slope member arranged on the second substrate,
wherein the second alignment layer is arranged on the second substrate and the second slope member.

12. The liquid crystal display of claim 11, wherein a declination slope direction of the first slope member is the first direction, and a declination slope direction of the second slope member is the second direction.

13. The liquid crystal display of claim 9, wherein an inclination angle of an oblique surface of the first slope member is twice a pre-tilt angle generated by the grooves of the first alignment layer.

14. The liquid crystal display of claim 9, wherein the first slope member and the second slope member comprise an organic material.

15. The liquid crystal display of claim 9, further comprising:
a plurality of gate lines and a plurality of data lines arranged on the first substrate;
a plurality of thin film transistors coupled with the gate lines and the data lines; and
a plurality of pixel electrodes coupled with the thin film transistors.

16. The liquid crystal display of claim 15, further comprising a common electrode arranged on the second substrate.

17. The liquid crystal display of claim 9, further comprising a common electrode arranged on the first substrate.

18. The liquid crystal display of claim 17, further comprising:
a plurality of gate lines and a plurality of data lines arranged on the second substrate;
a plurality of thin film transistors coupled with the gate lines and the data lines; and
a plurality of pixel electrodes coupled with the thin film transistors.

19. A liquid crystal display, comprising:
a first substrate;
a slope member arranged on the first substrate;
a first alignment layer arranged on the first substrate and the slope member;
a second substrate opposing the first substrate;
a second alignment layer arranged on the second substrate; and
a liquid crystal layer arranged between the first substrate and the second substrate, the liquid crystal layer comprising liquid crystal molecules,
wherein liquid crystal molecules in a region where the slope member is arranged are raised in the opposite direction of liquid crystal molecules in a region without a slope member.

20. The liquid crystal display of claim 19, wherein a declination slope direction of the slope member is the same as a direction in which grooves of the first alignment layer are aligned.

21. A liquid crystal display, comprising:
a first substrate;
a first slope member arranged on the first substrate;
a first alignment layer arranged on the first substrate and the first slope member;
a second substrate opposing the first substrate;
a second slope member arranged on the second substrate;
a second alignment layer arranged on the second substrate and the second slope member; and
a liquid crystal layer arranged between the first substrate and the second substrate, the liquid crystal layer comprising liquid crystal molecules and having positive dielectric anisotropy,
wherein liquid crystal molecules in a region where the first slope member is arranged are raised in the opposite direction of liquid crystal molecules in a region without a first slope member, and the first slope member and the second slope member comprise an organic material.
